(19) United States
(12) Patent Application Publication
(10) Pub. No.: US 2007/0059427 A1
(43) Pub. Date: Mar. 15, 2007

(54) Extended refrigerated shelf life mashed potatoes

(76) Inventors: Thomas Dohman, Richland, WA (US); Jeffrey Schneider, Benton City, WA (US); Gilbert Boldt, Naperville, IL (US)

Correspondence Address: SUITER WEST SWANTZ PC LLO, 14301 FNB PARKWAY, SUITE 220, OMAHA, NE, 68154, US

(21) Appl. No.: 11/489,281

(22) Filed: Jul. 19, 2006

Related U.S. Application Data
(63) Continuation of application No. 11/486,425, filed on Jul. 13, 2006.
(60) Provisional application No. 60/700,709, filed on Jul. 19, 2005.

(51) Int. Cl. A23L 1/216

(52) U.S. Cl. 426/637

(57) ABSTRACT

The present invention relates to an extended refrigerated shelf life mashed potato product, the processes, and the system used to make the product. In particular, the present invention relates to a process of substantially reducing Bacillus cereus spores and non-proteolytic Clostridium botulinum spores in mashed potatoes.

### CROSS-REFERENCE TO RELATED APPLICATION

The present application is a continuation of U.S. patent application filed via Express Mail Label No. EV 764 985 412 US on Jul. 13, 2006 (for which a serial number has not yet been received), which claims the benefit under 35 U.S.C. §119(e) of U.S. Provisional Application Ser. No. 60/700,709 filed on Jul. 19, 2005. U.S. patent application filed via Express Mail Label No. EV 764 985 412 US on Jul. 13, 2006 and U.S. Provisional Application No. 60/700,709 are herein incorporated by reference in their entirety.

### FIELD OF THE INVENTION

The present invention generally relates to an extended refrigerated shelf life mashed potato product, the process, and the system used to make the product.

### BACKGROUND OF THE INVENTION

Mashed potatoes are widely consumed throughout the world; however, in a society that has little time, making fresh mashed potatoes becomes time consuming and burdensome. As such, commercially prepared potatoes have become more popular, since purchasing commercially prepared potatoes saves consumers time and effort. One of the major concerns with commercially prepared mashed potato products, however, is the growth of microbial organisms, such as bacteria because of the high water activity and the neutral pH of the product. In particular, two bacteria that are of the most concern are psychrotrophic Bacillus cereus and non-proteolytic Clostridium botulinum, specifically because these types of bacteria have the ability to grow at refrigeration temperatures.

Various types of commercially prepared mashed potatoes are currently available, including frozen mashed potato products and refrigerated mashed potato products. The frozen mashed potato products have an extended shelf life because temperatures below freezing inhibit the growth of microbial organisms such as bacteria. However, frozen mashed potato products are difficult to portion (i.e., remove a desirable amount for preparation and/or heating), and generally must be thawed before portioning. Whereas refrigerated mashed potato products are not substantially rigid and can easily be portioned in desired amounts. Additionally, refrigerated mashed potato products reconstitute more quickly than frozen mashed potato products. For these reasons, there is a desire for refrigerated fresh-like mashed potatoes.

Current refrigerated mashed potato products have achieved a shelf life of approximately 10 to 14 days, as the growth of microbial organisms can be retarded by refrigeration at a temperature of between 32-38° F. There are various processes used to make refrigerated mashed potatoes. One process includes heating the mashed potatoes to 187° F., cooling them to about 40° F., and filling them into the appropriate container. The problem with this process is that the temperature that the mashed potatoes are heated to is not sufficient to kill or even cause a substantial reduction of the bacterial spores in the potatoes. In particular, a 2 to a 6 log reduction of non-proteolytic C. botulinum spores and a 1 to a 3 log reduction in B. cereus spores are not achieved. In addition, the process includes a cold fill, which has the potential of allowing bacterial recontamination of the product and growth of the existing bacteria.

Other processes include the addition of chemical preservatives such as chemical additives, standard preservatives and/or emulsifiers. The chemical additives are included to maintain appearance and inhibit microbes. For example, sodium bisulfite is a common additive, which retards nonenzymatic browning of the mashed potatoes. Another preservative that is commonly added to mashed potatoes is potassium sorbate. These chemicals, although helpful in inhibiting bacterial growth, generally impart an inferior taste to the mashed potatoes and are still limited in the ability to impart an extended shelf life onto the product.

Accordingly, a need still exists for an effective process for making a refrigerated mashed potato product that has an extended refrigerated shelf life and has a minimal bacterial count but does not include chemical preservatives.

### SUMMARY OF THE INVENTION

The present invention is directed to a mashed potato product having a reduced bacterial count whereby the potato product does not include chemical preservatives and has a refrigerated shelf life of from about 70 to about 130 days. The present invention also includes processes and a system for producing the product.

One process includes preparing an amount of mashed potatoes, uniformly heating the mashed potatoes to a minimum temperature of at least about 212° F. to achieve from about a 2 to about a 6 log reduction of non-proteolytic C. botulinum spores and from about a 1 to about a 3 log reduction in B. cereus spores, maintaining the mashed potatoes at the heating temperature for a time effective to reduce the intended spore counts, cooling the mashed potatoes to a temperature of about 165° F., and filling the mashed potatoes into a gas and fluid impermeable, seated package.

The process is continuous and is performed in a sealed system such that bacterial contamination is prevented. The system includes a heating apparatus to heat the mashed potatoes and a circulating line for circulating the mashed potatoes from the exit of the heating apparatus through the circulating line to a cooling apparatus. The circulating line provides additional residence time to maintain the mashed potatoes at approximately the heating temperature. The system also includes a cooling apparatus to cool the mashed potatoes, a transfer line for transporting the cooled mashed potatoes to a filling apparatus, a steam valving apparatus in the transfer line to prevent bacterial recontamination of the cooled mashed potatoes, and a filling apparatus to fill the mashed potatoes into a gas and fluid impermeable, sealed package.

The resultant mashed potatoes have less than about 3.33 cfu/g aerobic plate count (APC), less than about 10 cfu/g mold and yeast count (MYC), and less than about 10 cfu/g total coliform count (TCC). In addition, the resultant mashed potatoes have from about a 2 to about a 6 log reduction of non-proteolytic C. botulinum spores and from about a 1 to about a 3 log reduction in B. cereus spores from the prepared unprocessed mashed potatoes.

### BRIEF DESCRIPTION OF THE FIGURES

FIG. 1 is a schematic flow diagram of the process of the invention, illustrating the continuous manufacture of extended refrigerated shelf life mashed potatoes.

FIG. 2 is a schematic diagram of the apparatus of the present invention.

### DESCRIPTION OF THE PREFERRED EMBODIMENTS

In accordance with the present invention a process for making an extended refrigerated shelf life mashed potato product having an extended refrigerated shelf life has been discovered. More particularly, a process of substantially reducing Bacillus cereus spores and non-proteolytic Clostridium botulinum spores has been devised wherein the mashed potato product does not include chemical preservatives. Even more particularly, the present invention is directed to a process of making a mashed potato product having an aerobic plate count of less than about 3.3 cfu/g, a mold yeast count of less than about 10 cfu/g, and a total coliform count of less than about 10 cfu/g, whereby the product does not include chemical preservatives and has a refrigerated shelf life of from about 90 to 130 days.

I. Making Mashed Potatoes

The mashed potatoes of the present invention may be prepared by any method generally known in the art. For example, a continuous supply of fresh potatoes may be washed, peeled, and scrubbed. The scrubbed potatoes may then be diced and cooked in a water blancher and/or steam cooker for a period of between 15 to 90 minutes. The cooked potatoes are then riced (i.e., pushed through a plate with uniform openings to mash the potatoes) and mixed with a variety of ingredients including, but not limited to, dairy-based ingredients, spices, and/or herbs in a mixing tank to form prepared mashed potatoes. The prepared mashed potatoes are then transferred to a holding tank. Alternatively, dairy ingredients, spices, and/or herbs may be added during the mashed potato cooking process.

II. Extended Refrigerated Shelf Life Mashed Potato Process

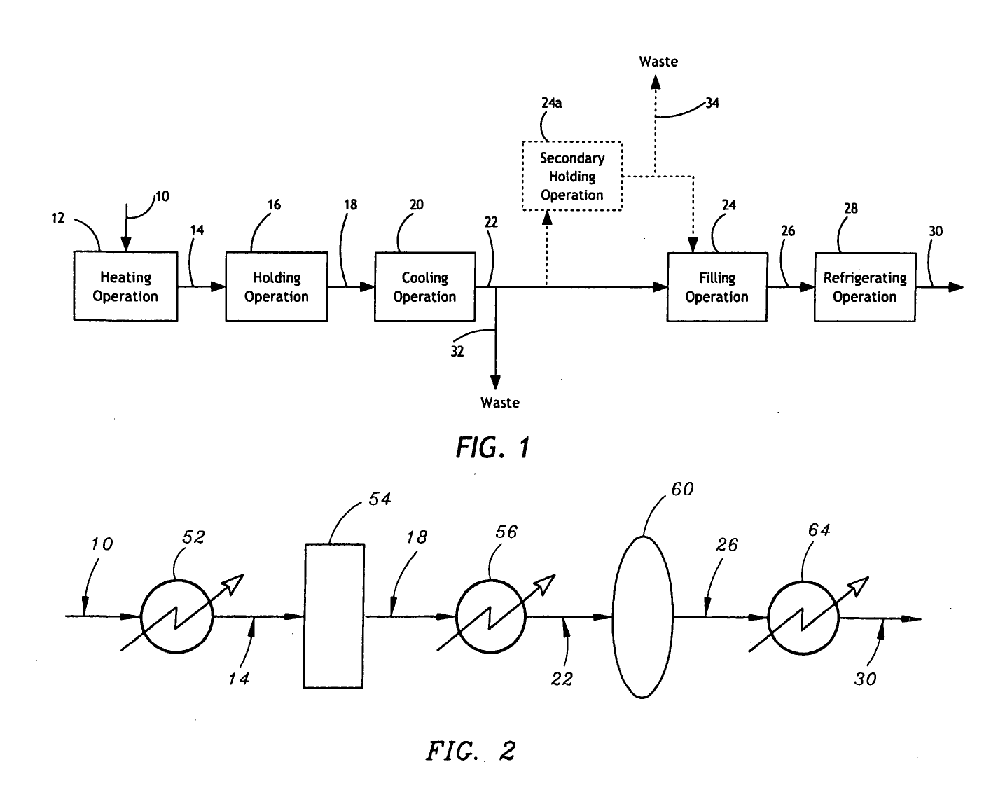

For purposes of illustration the process of making the extended refrigerated shelf life mashed potato product will be described with reference to FIG. 1.

The prepared mashed potatoes 10 are subjected to a heating operation 12 to obtain a heated mashed potato product 14. The mashed potatoes may, for example, be subjected to a one stage or a multistage heating operation. In particular, the heating operation has to be suitable to thoroughly heat a viscous mashed potato product so that the internal temperature of the mashed potato product is substantially the same throughout (i.e., the temperature of the mashed potato product within the heating apparatus is substantially the same regardless of its positioning within the apparatus).

Typically, the heating operation includes heating the mashed potatoes uniformly to a temperature of from about 170° F. to about 230° F. More preferably, the heating operation includes heating the mashed potatoes to a temperature of at least 212° F. The heated mashed potatoes 14 are then subjected to a holding operation 16. This holding operation ensures that the heated mashed potatoes have the required internal temperature for a requisite minimum hold time so as to achieve the required log reduction in non-proteolytic C. botulinum spores and in B. cereus spores and the desired reduction in aerobic plate counts, mold and yeast counts, and total coliform counts. Typically the heating operation is continued for from about 60 to about 600 seconds, preferably from about 60 to about 120 seconds, and even more preferably for at least about 60 seconds. Once the internal temperature has been achieved, the heated held mashed potatoes 18 are subjected to a cooling operation 20 to produce cooled mashed potatoes 22. If the internal temperature is not achieved, the heated held mashed potatoes are cooled and disposed of 32.

The heated held mashed potatoes 18 of the present invention may, for example, be subjected to a one stage or a multistage cooling operation. The cooling operation should be suitable to cool a viscous mashed potato product. The thoroughly heated mashed potatoes are usually cooled to a temperature where the mashed potatoes do not solidify, or rather where the mashed potatoes are still fluid. In addition, by maintaining a hot temperature, the concern for post process bacterial recontamination is eliminated. Preferably, the cooling operation includes cooling the mashed potatoes to a temperature of from about 160° F. to about 180° F., more preferably to a temperature of at least about 170° F. Typically, the heated held mashed potatoes are subjected to the cooling operation for from about 30 seconds to about 10 minutes.

The cooled mashed potatoes 22 are then subjected to an optional secondary holding operation 24a prior to filling operation 24 wherein the cooled mashed potatoes are packaged. The packaged mashed potatoes 26 are then subjected to a refrigerating operation 28 to produce an extended refrigerated shelf life mashed potato product 30. Preferably, the refrigerating operation includes cooling the mashed potato product to a temperature of from about 33° F. to about 40° F., more preferably at a temperature of about 34° F. The extended refrigerated shelf life mashed potato product 30 is then cased and kept under refrigeration at a temperature of 33° F. to about 40° F. The cooling operation and the refrigerating operation generally have a duration of from about 120 to about 240 minutes. Typically, the packaged mashed potatoes are subjected to the refrigeration operation, cooling the packaged mashed potatoes from a temperature of approximately 170° F. to about 40° F., for from about 1 to about 3 hours, preferably less than about 2 hours.

The process of making the mashed potato product may be conducted in a semi-continuous or continuous mode and it may be carried out using a variety of apparatus and process techniques. In some instances, some process steps may be omitted or combined with other process steps without departing from the scope of the present invention.

III. Extended Refrigerated Shelf Life Mashed Potato System

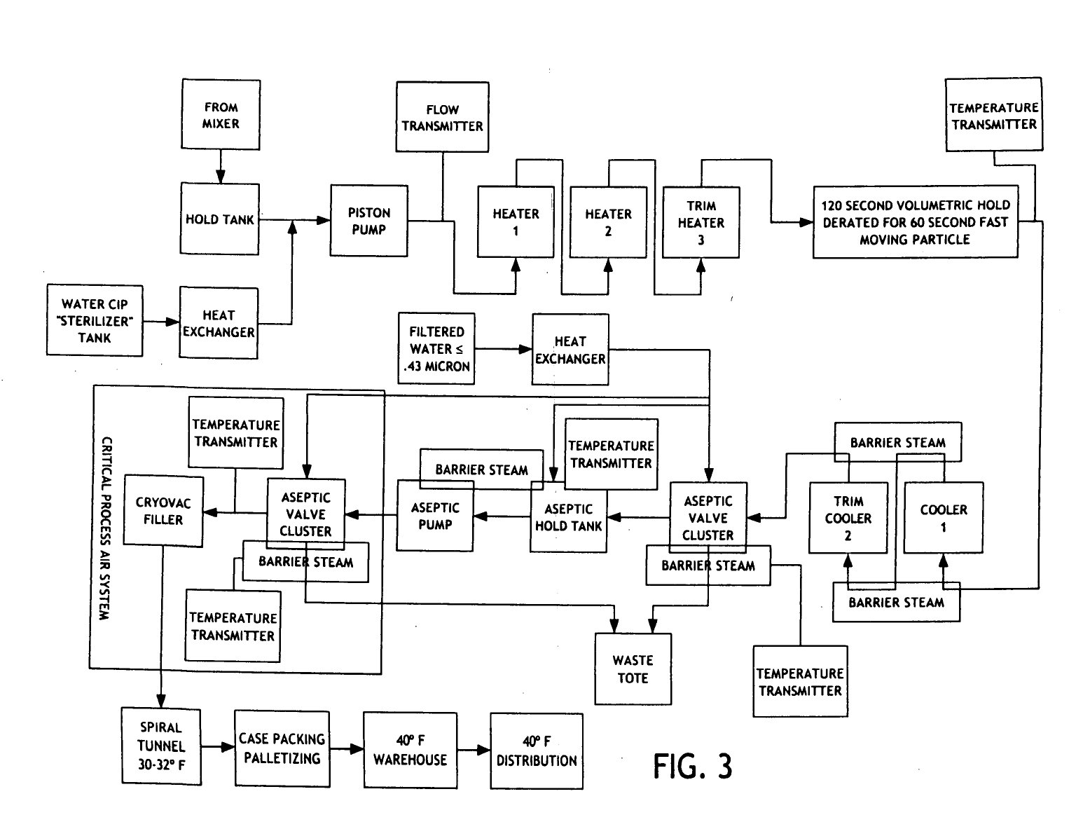

For purposes of illustration the system used in making an extended refrigerated shelf life mashed potato product will be described with reference to FIG. 2.

Typically, the prepared mashed potatoes 10 are heated in a heating apparatus 52 to reduce the bacterial count of the mashed potatoes and produce a heated mashed potato product 14. The particular construction and configuration of the heating apparatus 52 used is not critical in the practice of the present invention. In particular, the heating apparatus 52 has to be suitable to thoroughly heat the viscous mashed potatoes so that the internal temperature of the mashed potato product is substantially the same throughout (i.e., the temperature of the mashed potato product within the heating apparatus is substantially the same regardless of its positioning within the apparatus). Preferably, the heating apparatus 52 is a suitable heat exchanger. Preferably the heating apparatus 52 may comprise one or multiple heat exchangers in a series. More preferably, the heat exchanger is a scraped surface heat exchanger. Alternative devices may be used to heat the mashed potatoes.

In accordance with the present invention, after the mashed potatoes are heated in the heating apparatus 52 they are circulated from the exit of the heating apparatus 52 through a circulating line 54 to a cooling apparatus 56. The circulating line 54 provides additional residence time to maintain or hold the heated mashed potatoes 14 at approximately the heating temperature and ensure that the product has achieved the desired bacterial reduction. The circulating line 54 may be insulated to ensure minimal heat loss. The circulating line 54 may additionally comprise one or several temperature measuring devices to accurately ascertain the temperature of the mashed potatoes. Alternatively, any other vessel design that achieves a first-in-first-out means of ensuring that the mashed potatoes have the required internal temperature for a requisite minimum hold time so as to achieve a log reduction in non-proteolytic C. botulinum spores, B. cereus spores, and the desired aerobic plate count, mold and yeast count, and total coliform count may also be used.

The heated held or circulated mashed potatoes 18 are then cooled in a cooling apparatus 56 making cooled mashed potatoes 22. The particular construction and configuration of the cooling apparatus 56 used is not critical in the practice of the present invention. In particular, the apparatus has to be suitable to cool a viscous mashed potato product. Preferably the cooling apparatus 56 may comprise one or multiple heat exchangers in a series. More preferably, the heat exchanger is a scraped surface heat exchanger.

The cooled mashed potatoes 22 are then transferred to a filling apparatus 60 through a transfer line. During start-up or if a system upset occurs, a portion of the cooled mashed potatoes 22 may need to be removed and sent to waste. The transfer line preferably comprises a steam valving apparatus. The steam valving apparatus prevents bacterial contamination of the mashed potatoes in the transfer line from the removed mashed potatoes by continuously flushing the valve connection between the process and waste pipelines with steam. The high temperature of the steam ensures that all possibility of bacterial contamination is eliminated from the valve connection. In addition, the steam valving apparatus eliminates product contamination by flushing the waste pipeline with water and then steam after any portion of the mashed potatoes is sent to waste.

In the filling apparatus 60 the cooled mashed potatoes 22 are filled into a gas and fluid impermeable sealed packages. The filling apparatus 60 may be any apparatus that is suitable for handling the viscous flow of mashed potatoes such as bag fillers. The particular construction and configuration of the apparatus used in the filling operation is not critical, for example, in the practice of the present invention if the aseptic hold tank is not part of the filling system. For instance, the filling apparatus 60 may be a bag filler or any other filling apparatus that is suitable for handling the viscous flow of mashed potatoes. Preferably, the filling operation is performed in a HEPA filtered room wherein any bacterial recontamination from the atmosphere can be eliminated. In addition, the mashed potato product packages are preferably hermetically sealed to prevent any bacterial recontamination during shipping and subsequent refrigerated shelf life of the product.

The packaged mashed potatoes 26 may further be cooled in a refrigerating apparatus 64 to produce an extended refrigerated shelf life mashed potato product 30 having a reduced bacterial count. The particular configuration of the equipment used in the refrigerated operation is not critical in the practice of the present invention. The refrigerating apparatus 64 may be any apparatus that is suitable to cool the containerized mashed potatoes to a temperature of from about 33° F. to about 40° F.

Thus, the mashed potato product provides desired organoleptic qualities and an extended refrigerated shelf life without chemical preservatives, such as potassium sorbate, sodium benzoate, sodium bisulfite, and/or salt.

The process of making the extended refrigerated shelf life mashed potato product includes various processing factors. In specific embodiments of the invention, these processing factors are balanced in order to obtain a mashed potato product that is desirable to consumers (i.e., provides desired organoleptic qualities) and has an extended refrigerated shelf life. For example, in one specific embodiment, heating and cooling apparatus residence times are selected based on volume flow rate, as well as heating and cooling apparatus sizes (e.g., the area of a scraped surface heat exchanger available for heat exchange). In another specific embodiment, inlet and outlet temperatures are chosen based on volume flow rate and heat capacity. It will be appreciated that other processing factors, including processing apparatus sizes, the number of processing apparatuses, pressures, shear forces, flow rates, microbiological standards, and product specifications, may be balanced in the process of making the extended refrigerated shelf life mashed potato product.

Moreover, when heat exchangers are utilized for heating and cooling operations, the desired product outlet temperature, available processing area, operational costs, and product tolerances are balanced. To accommodate this balance, the heat exchanger may be oriented vertically or horizontally, and may include multiple heat exchange modules, clusters, and/or hybrid components for optimizing processing conditions. Additionally, where scraped surface heat exchangers (SSHE) are employed, the flow rate of the mashed potatoes, the annular flow area, and the rotational velocity of the rotating blades may be controlled such that the impact of the combined shear forces upon the finished product texture are minimized.

In another specific embodiment, processing apparatus residence times are selected based on processing factors including volume flow rate, shear forces, and heating and cooling rates. For instance, a throughput for the mashed potato product is chosen for a desired volume flow rate, such that the resulting shear forces generated during processing provide a mashed potato product having desired organoleptic properties. Further, time intervals for heating and cooling the mashed potato product (i.e., heating and cooling apparatus residence times) may be selected for providing the desired qualities. For example, rapid heating and cooling may produce a desired eating quality and organoleptic experience in the product.

In a specific embodiment, the heating apparatus 52 includes three scraped surface heat exchangers arranged in series. For instance, the prepared mashed potatoes 10 enter a first SSHE after preparation, and subsequently enter a second SSHE, and then a third SSHE. The first and second scraped surface heat exchangers are larger incremental heaters, while the third SSHE is a trim heater for finer temperature control. The third SSHE provides fine temperature change increments for enhanced control prior to the temperature-critical holding operation 16 in the circulating line 54. It will be appreciated that heat losses may occur within the circulating line 54; thus, it may be desirable to achieve a more precise temperature prior to the holding operation 16. The third SSHE may be ideal for achieving this temperature.

The cooling apparatus 56 includes two scraped surface heat exchangers arranged in series. For instance, the heated held mashed potatoes 18 enter a fourth SSHE after exiting the circulating line 54, and subsequently enter a fifth SSHE. The fourth scraped surface heat exchanger is a large incremental cooler, while the fifth SSHE is a trim cooler for finer temperature control. The fifth SSHE provides fine temperature change increments for enhanced control prior to the filling operation 24. For example, maintaining the cooled mashed potatoes 22 above a critical temperature may be desirable for preventing bacterial recontamination of the mashed potatoes during the filling process 24. It should be noted that this exemplary embodiment is not meant to be restrictive, and more or fewer scraped surface heat exchangers may be utilized with the present invention, as well as other types of heating and cooling apparatus.

In specific embodiments, heating and cooling apparatus selection is based on the process flow rate and other above-listed processing factors, including the number and arrangement of the heating and cooling apparatus. For example, energy requirements for choosing the heating apparatus 52 and/or the cooling apparatus 56 may be specified by the function:
Energy Requirements∝ f(cₚ₁, cₚ₂ . . . cₚₙ, m₁, m₂ . . . mₙ, T₁, T₂ . . . Tₙ, Heat Transfer Area, Process Space)
   where cₚ represents heat capacity, m represents mass, and T represents temperature. For instance, in a specific embodiment, the cooling apparatus 56 is selected based on energy requirements which are based on a heat capacity for the heated held mashed potatoes 18, a mass flow rate for the heated held mashed potatoes 18, the inlet temperature of the heated held mashed potatoes 18, the outlet temperature of the cooled mashed potatoes 22, the heat transfer area of the cooling apparatus 56, and the process space for positioning the cooling apparatus 56.
   IV. Extended Refrigerated Shelf Life Mashed Potato Product

The mashed potato product made by the process described above has a reduced bacterial count. In particular, the bacterial count of the resultant mashed potato product is reduced by from about a 2 to about a 6 log in non-proteolytic C. botulinum and by from about a 1 to about a 3 log of B. cereus spores from the prepared mashed potatoes. The resultant mashed potato product also has an aerobic plate count of less than about 3.3 cfu/g, a mold and yeast count of less than about 10 cfu/g, and a total coliform count of less than about 10 cfu/g.

The mashed potato product made by the method of the present invention also does not include chemical preservatives. Chemical preservatives include standard preservatives, additives, and/or emulsifiers. The exclusion of chemical preservatives ensures that the taste and texture of the mashed potato product remain the same as a home made mashed potato product made from fresh potatoes. In addition, the mashed potato product of the present invention has a refrigerated shelf life of from about 70 to about 130 days, more preferably from 90 to 120 days.

All publications, patents, patent applications and other references cited in this application are herein incorporated by reference in their entirety as if each individual publication, patent, patent application or other reference were specifically and individually indicated to be incorporated by reference.

The following examples are simply intended to further illustrate and explain the present invention. The invention, therefore, should not be limited to any of the details in these examples.

### EXAMPLES

It is generally known that bacteria die when subjected to the elevated temperatures found during cooking. It is widely accepted by microbiologists that bacteria die in a predictable, logarithmic way. This is referred to as first-order inactivation kinetics.

Many investigators do not show the inactivation data for their studies and merely quote D-values (i.e. time for a 90% reduction in the numbers of bacteria at a given temperature). Generally, these investigators will use regression analysis of data showing log₁₀ bacteria numbers vs. heating time. The equation of the regression line can be used to calculate a D-value over 1 log cycle reduction in the numbers of bacteria. When D-values are calculated for a number of different temperatures, a relationship between the D-value and the temperature can be calculated. Data expressed as the reciprocal of the D-value vs. temperature of the D-value can be analyzed by regression to give a straight line equation. This equation can be used to calculate a z-value, which is the temperature change required to bring about a 90% change in D-value. Hence, if the z-value=10° C. and a D-value at 70° C.=1 min, then by applying the z-value to the D-value we can see that the D-value at 80° C.=0.1 minute and the D-value at 60° C.=10 minutes. Therefore, with a D-value at a given temperature and a z-value for a bacterium in a given heating medium it is possible to calculate the reduction in the numbers of that bacterium at any other temperature.

### Example 1

This example studied the destruction of psychrotrophic B. cereus spores by varying the time and temperature at which mashed potato samples were heated.

For this work, four strains obtained from Larry Beuchat, Ph.D. (University of Georgia) were used. Spores from the 4 stains of psychrotrophic B. cereus were prepared by spreading overnight cultures on Nutrient Agar with Manganese Sulfate (NAMS) Petri plates, incubating at 30° C. for 4 days and harvesting using sterile glass microscope slides. Numerous washes, vortexes, and a sonicating bath were used to obtain clean spore suspensions with minimum clumps, and this was confirmed with microscopy.

Approximately an equal number of each spore crop was thoroughly mixed with the mashed potatoes. Studies with inoculated mashed potato were done using 50 g of potatoes in an ultra thin “read-through” layer measuring 6¾ inch×9 inch in heat-sealed pouches made from Whirl-pak bags. The potato layer was formed by using a 1000-ml laboratory bottle as a “rolling pin” to roll the potatoes to dimension. The bag was then sealed under vacuum using a Multivac machine. Pouches were processed individually (3 replicates at each time/temperature) by inserting them into the middle support of a wide wire test tube rack and immersing them completely into a controlled temperature bath. Ethylene glycol was used for the bath fluid to achieve stable temperatures above 208° F. After immersion for the specified time, the potato pouches were rapidly cooled by transferring them into an ice bath. Enumeration of B. cereus spores was done using mannitol yolk polymyxin (MYP) agar incubated at 86° F. for 24 to 48 hrs (rechecked for additional growth). Earlier work showed B. cereus spores grew equally well on MYP and brain heart infusion (BHI) agar.

This method allowed for a short temperature equilibration time, and very precise, accurate holding temperatures for the inoculated product.

TABLE 1
Lethality of psychrotrophic B. cereus spores using
thin film method - summary of data

| | Time | Survivors | | Log | D-value | Log D-value |
|---|---|---|---|---|---|---|
| Temp ° F. | (minutes) | arithmetic | logarithmic | Lethality | (minutes) | (minutes) |
| 180 | 0.00 | 36,000,000 | 7.56 | 0.00 | — | — |
| | 30.00 | 2,400,000 | 6.38 | 1.18 | 25.51 | 1.41 |
| 198 | 0.00 | 36,000,000 | 7.56 | 0.00 | — | |
| | 10.17 | 280,000 | 5.45 | 2.11 | 4.82 | 0.68 |
| 203 | 0.00 | 3,500,000 | 6.54 | 0.00 | — | — |
| | 0.17 | 2,600,000 | 6.41 | 0.13 | 1.32 | 0.12 |
| | 1.17 | 1,100,000 | 6.04 | 0.50 | 2.33 | 0.37 |
| | 3.17 | 300,000 | 5.48 | 1.07 | 2.97 | 0.47 |
| | 5.17 | 80,000 | 4.90 | 1.64 | 3.15 | 0.50 |
| | 10.17 | 500 | 2.70 | 3.85 | 2.64 | 0.42 |
| 208 | 0.00 | 36,000,000 | 7.56 | 0.00 | — | — |
| | 3.00 | 40,000 | 4.60 | 2.95 | 1.02 | 0.01 |
| 212 | 0.00 | 510,000 | 5.71 | 0.00 | — | — |
| | 0.17 | 180,000 | 5.26 | 0.45 | 0.38 | −0.42 |
| | 0.67 | 120,000 | 5.08 | 0.63 | 1.07 | 0.03 |
| | 1.17 | 40,000 | 4.60 | 1.11 | 1.06 | 0.02 |
| | 1.67 | 8,900 | 3.95 | 1.76 | 0.95 | −0.02 |
| | 2.17 | 3,300 | 3.52 | 2.19 | 0.99 | 0.00 |

It was determined that heating the mashed potatoes at a temperature of 212° F. for short duration of 1 minute causes a destruction of approximately one log psychrotrophic B. cereus in a mashed potato product.

### Example 2

This example studied the destruction of psychrotrophic B. cereus spores over one minute as the mashed potato samples were heated to a temperature of approximately 212° F.

Four psychrotrophic B. cereus strains were reisolated, from the ones used in example 1, by streaking onto a MYP agar and incubated at 86° F. for 48 h. An isolated colony of each strain was transferred to brain heart infusion broth and incubated overnight at 86° F. A 0.1 ml of culture from each tube was spread onto nutrient agar supplemented with manganese sulfate (NAMS) to induce sporulation. After incubating at 86° F. for 4 days, spores were removed, washed with 0.85% saline solution, using centrifugation to remove vegetative cells, and vortexed with sterile glass beads to break up any spore clumps. Suspensions were examined using phase contrast microscopy to ensure lack of significant numbers of vegetative cells and lack of significant spore clumps.

Equal volumes of each of the four B. cereus strains were combined to achieve ≈10⁷ CFU/mL suspension in the first experiment and for the second experiment, this suspension was diluted to ≈10⁶ CFU/ml in 0.1% peptone water. One drop of food coloring was added to a 10-ml aliquot of these spore suspensions to allow for visible confirmation of uniform distribution of spores into the potatoes.

Before inoculating, 3,000 g of mashed potatoes were heated to approximately 212° F. in a stainless steel mixing bowl placed in a circulating water bath heated to 275° F. (a 50:50 antifreeze: water solution was used in the bath to achieve this temperature). In order to maintain temperature of the potatoes as closely as possible and allow for mixing, the bowl was covered with 4 layers of cotton fabric and one layer of aluminum foil. Potato and water bath temperatures were monitored continuously using a type K thermocouple probe and data was recorded using a Pico Technology TC-08 data logger (Pico Technology Limited, St. Neots, United Kingdom). The probe recording the potato temperature was fastened to a stainless steel spoon inserted through the center of the insulating fabric.

Inoculum was added through a hole in the insulation and the potatoes were then mixed vigorously using the stainless steel spoon while duplicate samples were collected with sterile plastic spoons after approximately 15, 30, 45, and 60 sec. An additional 3,000 g of potatoes were inoculated in a similar manner (mixing for 15 sec, etc.) to obtain a spore count under non-heated (Time 0) conditions.

At time 0 and designated intervals after, samples were obtained and transferred into whirl-pak bags containing pre-chilled 0.1% peptone water. Samples were then placed in an ice water bath for additional chilling. B. cereus levels were enumerated by surface plating decimal dilutions onto MYP agar. Plates were incubated at 86° F. and counted after 24 and 48 h.

This method eliminated temperature equilibration time and allowed a small amount of variation in time/temperature exposure for the product. The temperature was tracked precisely in these experiments using a thermocouple probe with a data logger. Data from these three studies are presented in Table 2.

TABLE 2
Levels of B. cereus (log₁₀ CFU/g) in mashed
potatoes after various exposure times^{a}. Water
bath and potato temperatures are also presented.

| | | | |
|---|---|---|---|
| Time | B. cereus | | |
| (sec) | Levels | Potato Temp. | Water bath Temp. |

Replicate 1

| | | | | | |
|---|---|---|---|---|---|
| 0 | 5.0 | 211.6° F. | (99.8° C.) | 275.5° F. | (135.3° C.) |
| 30 | 2.8 | 210.7° F. | (99.3° C.) | 275.2° F. | (135.1° C.) |
| 45 | 2.3 | 210.2° F. | (99.0° C.) | 275.0° F. | (135.0° C.) |
| 60 | 2.6 | 210.2° F. | (99.0° C.) | 275.0° F. | (135.0° C.) |

Replicate 2

| | | | | | |
|---|---|---|---|---|---|
| 0 | 5.7 | 212.5° F. | (100.3° C.) | 257.7° F. | (125.4° C.) |
| 15 | 4.3 | 210.4° F. | (99.1° C.) | 257.7° F. | (125.4° C.) |
| 30 | 4.1 | 210.9° F. | (99.4° C.) | 257.7° F. | (125.4° C.) |
| 45 | 4.2 | 209.1° F. | (98.4° C.) | 257.5° F. | (125.3° C.) |
| 60 | 4.2 | 210.9° F. | (99.4° C.) | 257.5° F. | (125.3° C.) |

Replicate 3

| | | | | | |
|---|---|---|---|---|---|
| 0 | 4.1 | 211.8° F. | (99.9° C.) | 256.6° F. | (124.8° C.) |
| 15 | 2.8 | 209.1° F. | (98.4° C.) | 256.3° F. | (124.6° C.) |
| 30 | 2.9 | 209.8° F. | (98.8° C.) | 256.3° F. | (124.6° C.) |
| 45 | 2.8 | 210.2° F. | (99.0° C.) | 256.3° F. | (124.6° C.) |
| 60 | 2.8 | 210.6° F. | (99.2° C.) | 256.3° F. | (124.6° C.) |

^{a}B. cereus levels are expressed as an average of duplicate samples.

The average log reduction of B. cereus spores in the mashed potato sample demonstrated by three replications of this study, as can be seen in Table 2 above, was 1.8 logs at approximately 212° F. for 60 sec. This example confirms the Meer et al. (1991) cited data from Shehata and Collins (1972) for psychrotrophic B. cereus spores that indicate a 1.98-log destruction in 1 min at 212° F. These lethality rates are greater than those reported for B. cereus spores in rice broth, distilled water, and phosphate buffer (0.12-0.24 log destruction in one min at 212° F.) or pumpkin pie (0.02 log destruction in one min at 212° F.); however, these published results do not distinguish between mesophilic and psychrotrophic strains (ICMSF 5).

### Example 3

This example determined the aerobic plate count (APC), the mold count, and the yeast count of a mashed potato product inoculated with the same strain used in Example 1 heated to 213° F. for 1 min, and then stored at 40° F. for 147 days. After 147 days the experiment was terminated. Sample 1 and Sample 2 are duplicate samples.

TABLE 3
Mashed potatoes heat treated at 213° F. for 1 min and stored at 40° F.

| | APC (CFU/g) | | Yeast (CFU/g) | | Mold (CFU/g) | |
|---|---|---|---|---|---|---|
| | Sample | | Sample | | Sample | |
| Day | 1 | Sample 2 | 1 | Sample 2 | 1 | Sample 2 |
| 5 | 20 | 10 | <10 | <10 | <10 | <10 |
| 27 | <10 | <10 | <10 | <10 | <10 | <10 |
| 35 | <10 | 20 | <10 | <10 | <10 | <10 |
| 49 | 10 | 10 | <10 | <10 | <10 | <10 |
| 63 | <10 | <10 | <10 | <10 | <10 | <10 |
| 77 | <10 | <10 | <10 | <10 | <10 | <10 |
| 91 | <10 | 10 | <10 | <10 | <10 | <10 |
| 106 | <10 | <10 | <10 | <10 | <10 | <10 |
| 119 | <10 | <10 | <10 | <10 | <10 | <10 |
| 133 | 10 | <10 | <10 | <10 | <10 | <10 |
| 147 | <10 | <10 | <10 | <10 | <10 | <10 |

APC: aerobic plate count

As shown on Table 3, the mashed potato samples had less than 10 CFU/g APC, less than 10 CFU/g yeast count, and less than 10 CFU/g mold count even after 147 days. The experiment demonstrated the microbial stability of the product, showing no significant microbial growth within 147 days in the product.

### Example 4

This example determined the aerobic plate count (APC), the anaerobic plate count (AnPC) and the psychrotrophic B. cereus count of a mashed potato product inoculated with the same strain used in Example 1 heated to 213° F. for 1 min, and then stored at 40° F. for 140 days. It also determined the aerobic plate count (APC), the anaerobic plate count (AnPC) and the psychrotrophic B. cereus count of a mashed potato product inoculated with the same strain used in Example 1 heated to 213° F. for 1 min, and then stored at 40° F. for 70 days and then either 6, 14, or 21 days at 55° F.

TABLE 4A
Mashed potatoes shelf life at 40° F. and B. cereus inoculated challenge
data.

| | | | |
|---|---|---|---|
| | | | B. cereus |
| Day | APC | AnPC | Count |

| | | | | | | |
|---|---|---|---|---|---|---|
| 0 | 20 | 20 | <10 | 10 | 1200 | 1900 |
| 13 | <10 | <10 | <10 | <10 | <100 | 100 |
| 28 | <10 | <10 | <10 | <10 | <100 | 100 |
| 42 | <10 | 10 | <10 | <10 | <100 | <100 |
| 70 | 80 | 120,000 | <10 | <10 | <100 | <100 |
| 91 | <10 | <10 | <10 | <10 | 700 | 2500 |
| 105 | <10 | <10 | <10 | <10 | <100 | <100 |
| 119 | 10 | <10 | <10 | <10 | <100 | 100 |
| 133 | 10 | <10 | <10 | 10 | <100 | <100 |
| 140 | <10 | <10 | <10 | <10 | <100 | <100 |

APC: Aerobic plate count;
AnPC: Anaerobic plate count

TABLE 4B
Mashed potatoes shelf life (70 days at 40° F. and then either 6, 14, or 21
days at 55° F.) and B. cereus inoculated challenge data.

| Day | APC | | AnPC | | B. cereus Count | |
|---|---|---|---|---|---|---|
| 70 + 6 | <10 | <10 | <10 | 10 | <100 | <100 |
| 70 + 14 | <10 | <10 | <10 | <10 | <100 | 4700 |
| 70 + 21 | <10 | <10 | <10 | <10 | <100 | 110,000 |

The results showed no significant growth or reduction of APC, AnPC, and psychrotrophic B. cereus count when stored at 40° F. for up to 140 days, as shown on Table 4A. When one sample was moved to 55° F. storage, after 70 days at 40° F., the spore count of B. cereus increased from <100/g to as high as 110,000/g after 21 days while the APC and AnPC remained the same, as shown on Table 4B.

### Example 5

This example illustrates the process of making the refrigerated extended shelf life mashed potato product of the present invention.

A continuous supply of fresh potatoes were washed, peeled, and scrubbed. The potatoes were then diced and cooked in a water blancher for between 15 and 90 minutes. The cooked potatoes were then riced and mixed with a variety of ingredients including, dairy-based ingredients, spices and herbs and then transferred to a holding tank.

The prepared mashed potatoes were then fed into a series of scraped surface heat exchangers that uniformly heat the prepared mashed potatoes to a temperature of at least 212° F. The heated mashed potatoes were then held for 60 seconds to ensure that that the internal temperature of the mashed potato product was substantially the same throughout, having a minimum temperature of 212° F. The heated, held mashed potatoes were then cooled for 10 minutes to a temperature of 170° F. The cooled mashed potatoes were then filled in a clean air environment into oxygen barrier packages, sealed, and cooled to between 33° F. and 40° F. before being cased and refrigerated at a temperature of 33° F. to 40° F.

### Example 6

This example illustrates the organoleptic properties of the refrigerated extended shelf life mashed potato product of Example 5 during a 98 day period. Samples were evaluated for overall product liking, liking of apperance, liking of flavor, and liking of texture on a standard nine-point hedonic scale. The scale is as follows:

| Score/Rating | Std. Hedonic Scale |
|---|---|
| 9 | I like extremely |
| 8 | I like very much |
| 7 | I like moderately |
| 6 | I like slightly |
| 5 | I neither like nor dislike |
| 4 | I dislike slightly |
| 3 | I dislike moderately |
| 2 | I dislike very much |
| 1 | I dislike extremely |

TABLE 5
Hedonic Mean Scores

| | PRODUCTS | | | | | | | |
|---|---|---|---|---|---|---|---|---|
| | 0 | 14 | 28 | | 56 | 70 | | |
| Attribute | Days | Days | Days | 42 Days | Days | Days | 84 Days | 98 Days |
| Overall Product Liking | 6.8 | 7.1 | 6.8 | 6.8 | 6.9 | 7.0 | 6.9 | 6.9 |
| Liking of Appearance | 6.9 | 7.2 | 7.2 | 7.2 | 7.1 | 7.1 | 7.1 | 7.1 |
| Liking of Flavor | 6.8 | 7.1 | 6.8 | 6.8 | 6.8 | 7.0 | 6.9 | 6.9 |
| Liking of Texture | 6.8 | 7.0 | 6.9 | 6.8 | 6.9 | 7.0 | 6.8 | 7.0 |

Means having different letters are significantly different at alpha = 0.1.
149 people were tested

The results show that over the 98 day period the overall product linking, liking of appearance, liking of flavor, and liking of texture did not change and remained at about 7.0, as shown on Table 5.

### Example 7

The samples of example 5 were also evaluated for color, potato flavor, butter flavor, saltiness, pepper flavor, thickness, and texture. The samples were evaluated using a 10-point categorical scale. Intensity scales measure the degree to which consumers rate products as different or not different in amount or intensity of specific attributes. It does not indicate liking.

TABLE 6
Intensity Mean Scores

| | PRODUCTS | | | | | | | |
|---|---|---|---|---|---|---|---|---|
| Attribute | 0 Days | 14 Days | 28 Days | 42 Days | 56 Days | 70 Days | 84 Days | 98 Days |
| Color | 5.2 a | 5.0 ab | 4.9 cab | 4.7 cb | 4.8 cab | 4.5 c | 5.1 ab | 4.8 cb |
| (Very Light-Very Dark) | | | | | | | | |
| Potato Flavor | 5.8 | 6.1 | 6.0 | 5.9 | 5.8 | 6.1 | 6.1 | 6.0 |
| (Very Weak-Very Strong) | | | | | | | | |
| Butter Flavor | 5.1 | 5.4 ab | 4.9 b | 5.3 ab | 5.0 ab | 5.5 a | 5.2 ab | 5.1 ab |
| (Very Weak-Very Strong) | ab | | | | | | | |
| Saltiness | 4.4 | 4.4 | 4.5 | 4.5 | 4.2 | 4.2 | 4.4 | 4.2 |
| (Not at all salty-Very Salty) | | | | | | | | |
| Pepper Flavor | 3.8 | 3.7 | 3.7 | 3.5 | 3.5 | 3.7 | 3.8 | 3.5 |
| (Not at all peppery-Very | | | | | | | | |
| peppery) | | | | | | | | |
| Thickness | 7.0 | 7.1 | 7.0 | 6.9 | 7.0 | 6.9 | 7.1 | 7.1 |
| (Not at all thick-Very Thick) | | | | | | | | |
| Texture | 4.2 | 4.1 ab | 4.3 ab | 3.8 b | 4.5 a | 3.9 ab | 4.4 ab | 4.2 ab |
| (Very Smooth-Very Lumpy) | ab | | | | | | | |

Means having different letters are significantly different at alpha = 0.1.
149 people were tested

The results show that over the 98 day period the overall color, potato flavor, butter flavor, saltiness, pepper flavor, thickness, and texture did not change, as shown on Table 6.

### Example 8

The samples of example 5 were also evaluated for appearance, texture/mouthfeel, mouthfeel after swallowing, and flavor. In particular, the appearance was evaluated for speckles and extraneous material. The texture/mouthfeel was evaluated for thickness/viscosity, graininess, lumpiness, adhesiveness, and moistness of mass. The mouthfeel after swallowing was evaluated for mouthcoating. The flavors evaluated include potato ID, potato (processed), overall dairy, butter/butter-like, brothy, black pepper, warmed over, musty/earthy, overall sweet, salty, bitter, sour, and astringent flavors. The scale used for each category is as follows:

APPEARANCE:

| Speckles: | The degree to which dark black pepper - like spots appear | |
|---|---|---|
| | on or in the product. | |
| | Reference: | ⅛ tsp McCormick Black Pepper in 1 cup |
| | | Instant Potatoes = 10.0 |
| | Preparation: | Mix ⅛ tsp of black pepper in 1 cup of |
| | | Kroger Instant Potatoes prepared using box |
| | | instructions. |

| | |
|---|---|
| Extraneous | The perception of extraneous material in the sample that |
| Material: | may or may not be part of the natural potato, but are not |
| | appropriate to be found in mashed potato. |
| | (Number given reflects number of material pieces seen.) |

TEXTURE/MOUTHFEEL:

| Thickness/ | A measure of the consistency of the product when sample is manipulated against | |
|---|---|---|
| Viscosity: | roof of mouth with tongue. | |
| | Reference: | Kraft Miracle Whip Light Dressing = 10.0 |
| | | Jif Creamy Peanut Butter = 14.0 |
| Graininess: | Amount of fine particles detected in the mouth and on the tongue while the product | |
| | is being manipulated. | |
| | Reference: | Musselman's Apple Butter = 4.0 |
| Lumpiness: | The perception of particles that upon manipulation are relatively harder than the | |
| | surrounding product. (Number given reflects number of material pieces found.) | |
| Adhesiveness: | Degree to which sample adheres to mouth/palette surfaces during mastication. | |
| | Reference: | Kraft Miracle Whip Light Dressing = 7.0 |
| | | Jif Creamy Peanut Butter = 13.0 |
| Moistness of | The perceived amount of moisture in the product after being manipulated with | |
| Mass: | the tongue 5-7 times. Rinse before testing. | |
| | Reference: | Sara Lee All Butter Pound Cake (1″ × ½″ cube) = 6.0 |

After Swallowing

| Mouthcoating: | The perception of a film left in the mouth after | |
|---|---|---|
| | swallowing that maybe described as one or more of the | |
| | following: slick, sticky, or starchy. | |
| | Reference: | Philadelphia Fat Free Cream Cheese = 5.5 |

FLAVOR

| Potato ID: | The starchy, slightly metallic, cooked vegetable-like character associated with the | |
|---|---|---|
| | meat of a baked potato. | |
| | Reference: | Baked Potato = 8.0 (flavor) |
| | Preparation: | Scrubbed baking potato, baked in microwave oven for about 8 |
| | | minutes on high. Only meat portion is cut into cubes and placed |
| | | in individual 3.25 oz cups. |
| Potato (Processed): | A dried, processed impression associated with potato flakes. | |
| | Reference: | Kroger Instant Mashed Potatoes (dry) = 8.0 (flavor) |
| Overall | A general term for the aromatics associated with products made | |
| Dairy: | from cow's milk, excluding butter flavor. | |
| | Reference: | Kroger Regular Skim Milk = 4.5 (flavor) |
| | | Kroger 2% Milk = 8.0 (flavor) |
| | | Kroger Half and Half = 10.0 (flavor) |
| Butter/ | A sweet, natural or non-natural dairy-like aromatic, reminiscent of butter. | |
| Butter Like: | Reference: | Land O' Lakes Butter = 9.0 (flavor) |
| | | Parkay squeezable Margarine = 9.0 (flavor) |
| Brothy: | Aromatic sensation associated with “well cooked” meat or vegetable juices. | |
| | Reference: | Swanson Low-sodium Chicken Broth = 7.0 (flavor) |
| Black | Spicy, pungent, musty, and woody aromatics characteristic of ground | |
| Pepper: | black pepper. | |
| | Reference: | ⅛ tsp McCormick Black Pepper in 1 cup Instant Potatoes = 9.5 |
| | | (flavor) |
| | Preparation: | Mix ⅛ tsp of black pepper in 1 cup of Kroger Instant |
| | | Potatoes prepared using box instructions. |
| Warmed Over | Perception of a product that has been previously cooked and reheated. | |
| Flavor: | Reference: | Reheated Baked Potato = 2.0 (flavor) |
| | Preparation: | Day before - Bake potato in the microwave oven until soft and |
| | | tender (- 8 minutes.) Allow to cool before wrapping in plastic |
| | | wrap and storing in the refrigerator. |
| | | Day of testing - Reheat potato in the microwave oven for 2 |
| | | minutes. |
| Musty/Earthy: | Humus-like aromatics that may or may not include damp soil, decaying vegetation, | |
| | or cellar like characteristics. | |
| | Reference: | Baked Potato = 2.0 (flavor) |
| | Preparation: | Scrubbed baking potato, baked in microwave oven for about 8 |
| | | minutes on high. Only meat portion is cut into cubes and placed |
| | | in individual 3.25 oz cups. |
| Overall Sweet: | The perception of or combination of sweet taste and sweet aromatics. | |
| | Reference: | 1% Sucrose Solution = 1.0 |
| | | 2% Sucrose Solution = 2.0 |
| | | 3.0% Sucrose Solution = 3.0 |
| | | Post Shredded Wheat (Spoon size) = 1.5 |
| | | General Mills Wheaties = 3.0 |
| Salty: | A fundamental taste factor of which sodium chloride in water is typical. | |
| | Reference: | 0.2% Sodium Chloride Solution = 2.5 |
| | | 0.25% Sodium Chloride Solution = 3.5 |
| | | 0.35% Sodium Chloride Solution = 5.0 |
| Bitter: | The fundamental taste factor of which caffeine or quinine is typical. | |
| | Reference: | 0.01% Caffeine Solution = 2.0 |
| | | 0.02% Caffeine Solution = 3.5 |
| Sour: | A fundamental taste factor of which citric acid in water is typical. | |
| | Reference: | 0.015% Citric Acid Solution = 1.5 |
| | | 0.025% Citric Acid Solution = 2.5 |
| | | 0.08% Citric Acid Solution = 5.0 |
| Astringent: | The drying, puckering sensation on the tongue and other mouth surfaces. | |
| | Reference: | 0.03% Alum Solution = 1.5 |
| | | 0.05% Alum Solution = 2.5 |

TABLE 7
Descriptive Analysis Mean Scores

| | PRODUCTS | | | | | | | |
|---|---|---|---|---|---|---|---|---|
| | 0 | 14 | | | | | 84 | 98 |
| Attribute | Days | Days | 28 Days | 42 Days | 56 Days | 70 Days | Days | Days |
| Speckles | 2.5 a | 2.1 ab | 1.7 b | 1.8 b | 2.0 ab | 1.7 b | 1.9 ab | 2.1 ab |
| Extraneous Material | 0.7 ab | 1.1 a | 0.3 ab | 0.8 ab | 0.2 b | 0.3 ab | 0.3 ab | 0.8 ab |
| Thickness/Viscosity | 11.6 | 11.8 | 11.7 | 11.7 | 11.6 | 11.5 | 11.7 | 11.8 |
| Graininess | 6.2 | 6.4 | 6.2 | 6.3 | 6.2 | 6.4 | 6.2 | 6.1 |
| Lumpiness | 2.3 | 1.7 | 1.3 | 2.5 | 1.6 | 1.4 | 1.8 | 2.0 |
| Adhesiveness | 7.0 | 6.9 | 6.9 | 6.8 | 7.0 | 6.9 | 7.0 | 7.1 |
| Moistness of Mass | 6.7 ab | 6.7 ab | 6.7 ab | 6.8 ab | 6.8 ab | 7.1 a | 6.8 ab | 6.3 b |
| Mouthcoating | 4.7 | 4.8 | 4.6 | 4.6 | 4.8 | 4.5 | 4.5 | 4.8 |
| Potato ID | 7.5 | 7.4 | 7.4 | 7.7 | 7.6 | 7.6 | 7.3 | 7.3 |
| Potato (Processed) | 3.3 | 2.9 | 2.9 | 2.7 | 2.7 | 2.8 | 2.6 | 2.8 |
| Overall Dairy | 4.0 | 4.0 | 3.9 | 4.0 | 4.1 | 3.8 | 3.8 | 3.7 |
| Butter/Butter-Like | 4.0 | 4.5 | 4.2 | 4.4 | 4.2 | 4.0 | 4.3 | 4.3 |
| Brothy | 1.6 | 1.5 | 1.4 | 1.5 | 1.5 | 1.5 | 1.8 | 1.4 |
| Black Pepper | 1.8 | 2.0 | 2.0 | 1.8 | 1.7 | 1.7 | 1.8 | 1.9 |
| Warmed Over | 2.3 | 2.1 | 1.9 | 1.8 | 2.0 | 1.6 | 1.8 | 2.1 |
| Musty/Earthy | 1.2 | 1.2 | 1.3 | 1.3 | 1.2 | 1.1 | 1.2 | 1.1 |
| Overall Sweet | 2.2 | 2.1 | 2.2 | 2.3 | 2.2 | 2.2 | 2.3 | 2.1 |
| Salty | 4.5 ab | 4.5 ab | 4.6 a | 4.5 ab | 4.4 ab | 4.3 ab | 4.3 ab | 4.2 b |
| Bitter | 2.3 | 2.5 | 2.2 | 2.2 | 2.2 | 2.3 | 2.3 | 2.4 |
| Sour | 1.9 | 2.2 | 1.9 | 2.0 | 1.9 | 2.0 | 2.0 | 2.0 |
| Astringent | 1.4 | 1.8 | 1.5 | 1.5 | 1.6 | 1.6 | 1.3 | 1.8 |

* Means having different letters are significantly different at alpha = 0.05 Six Trained Sensory Panelists evaluated Mashed Potato products in Descriptive Analysis. Each panelist evaluated each product twice.

In general, the results show that over the 98 day period the appearance, texture/mouthfeel, mouthfeel after swallowing, and flavor did not change by more than 0.4, as shown on Table 7.

### Example 9

For this experiment, 20 g of the extended refrigerated shelf life mashed potato product from example 5 was mixed with 180 g H2O (1:10 dilution). It was this dilution that was used as the starting material for each of the tests below.

Aerobic Plate Count

The aerobic plate count was performed as described in AOAC Official Method 990.12. Generally speaking, 1 mL of the diluted potato product was inoculated onto the plate. The gel was allowed to solidify for 1 min, and then the plates were incubated for 48±3 hrs at 35±1° C. After incubation, the plates were counted with a standard colony counter. Colonies appeared red, and all colonies in countable range (30-300) were counted. The total number of colonies per plate was multiplied by the reciprocal of the dilution used. For the frozen potato product, approximately 50,000 CFU/g were counted, compared to <3.33 CFU/g for the refrigerated product (Table 8).

Mold and Yeast Count

The mold and yeast count was performed as described in AOAC Official Method 997.02. Generally speaking, 1 mL of the diluted potato product was inoculated onto the center of the plate. The gel was allowed to solidify for 1 min, and then the plates were incubated for 5 days at 20-25° C. After incubation, the plates were counted. Mold and yeast colonies were distinguished by color and colony morphology. The total number of colonies of mold and yeast per plate was multiplied by the reciprocal of the respective dilution used. For the frozen potato product, approximately 2,000 CFU/g were counted, compared to <10 CFU/g for the refrigerated product (Table 8).

Total Coliform Count

The total coliform count (TCC) was performed as described in AOAC Official Method 991.14. Generally speaking, diluted test portions were added to plates at a rate of 1.0 mL per plate. Pressure, when applied to plastic spreader placed on overlay film, spread the test portion over a 20 sq cm growth area. The gelling agent was allowed to solidify for approximately 1 min, and then the plates were incubated at 35° C. for 24±2 hours. Plates were subsequently counted, using a standard colony counter. Coliforms appear as red colonies that have one or more gas bubbles associated with them (within one colony diameter). All colonies within countable range (15-150) colonies were counted, and subsequently reported. For the frozen potato product, approximately 100 CFU/g were counted, compared to <10 CFU/g for the refrigerated product (Table 8).

E. Coli Count

The E. coli count was performed as described in AOAC Official Method 991.14. An indicator of glucuronidase activity was added to the plates, according to the Official Method. Generally speaking, diluted test portions were added to plates at a rate of 1.0 mL per plate. Pressure, when applied to plastic spreader placed on overlay film, spread the test portion over a 20 sq cm growth area. The gelling agent was allowed to solidify for approximately 1 min, and then the plates were incubated at 35° C. for 48±4 hours. Plates were subsequently counted, using a standard colony counter. E. coli colonies appear as blue colonies that have one or more gas bubbles associated with them (within one colony diameter). All colonies within countable range (15-150) colonies were counted, and subsequently reported. The frozen and the refrigerated potato product both had approximately <10 CFU/g E. coli (Table 8).

Coagulase Positive Staph. Count

The coagulase positive Staph. Count was performed as described in AOAC Official Method 975.55, 2001.05, and 2003.07. The method outlined in 975.55 is briefly outlined below. Generally speaking, 1 mL of the diluted test sample was plated to triplicate plates of Baird-Parker medium, and equitable distributed. After inoculum was absorbed, plates were inverted and incubated 45-48 hours at 35-37° C. Subsequently, the plates were counted according to the Official Method. If several types of colonies were observed which appeared to be S. Aureus, the count number of each type were recorded separately. One colony of each type counted was selected and tested for coagulase production.

Coagulase production was performed as outlined in AOAC Official Method 987.09 (referenced by Official Method 975.55). Briefly, the picked colony was transferred to a tube containing 0.2 mL BHI broth, and to an agar slant with a suitable maintenance medium. The BHI and the slant culture was incubated 18-24 hrs at 35° C. The slant culture was retained in case of ambiguous coagulase result. After incubation, 0.5 mL reconstituted coagulase plasma with EDTA was added to the BHI cultures, and thoroughly mixed. The mixture was incubated at 35-37° C., and examined periodically over a 6 hr interval for clot formation. Coagulase positive cultures (those with clots) were considered to be S. Aureus.

The number of colonies on triplicate plates represented by colonies giving positive coagulase test results were multiplied by the test sample dilution factor (1:10), and reported as number of S. aureus/g food tested. The frozen and the refrigerated potato product both had approximately <10 CFU/g S. Aureus (Table 8).

TABLE 8

| | | Micro | |
|---|---|---|---|
| Test | Temp. Class | Guideline | Sampling Method |
| Aerobic Plate Count (APC) | Frozen | 50,000/g | Petrifilm, 3M; AOAC #990.12 |
| Mold [symbol] Yeast Count (MYC) | Frozen | 2,000/g | Petrifilm, 3M; AOAC #997.02 |
| Total Coliform Count | Frozen | 100/g* | Petrifilm, 3M; AOAC #991.14 |
| (TCC) | | | |
| E. coli | Frozen | <10/g* | Petrifilm, 3M; AOAC #991.14 |
| Coagulase Positive Staph | Frozen | <10/g* | AOAC #975.55; APHA 33.613; |
| (CPS) | | | Petrifilm, 3M; AOAC #2001.05/ |
| | | | #2003.07 |
| Aerobic Plate Count (APC) | Refrigerated | <3.33/g** | Petrifilm, 3M; AOAC #990.12 |
| Mold [symbol] Yeast Count (MYC) | Refrigerated | <10/g* | Petrifilm, 3M; AOAC #997.02 |
| Total Coliform Count | Refrigerated | <10/g* | Petrifilm, 3M; AOAC #991.14 |
| (TCC) | | | |
| E. coli | Refrigerated | <10/g* | Petrifilm, 3M; AOAC #991.14 |
| Coagulase Positive Staph | Refrigerated | <10/g* | AOAC #975.55; APHA 33.613; |
| (CPS) | | | Petrifilm, 3M; AOAC #2001.05/ |
| | | | #2003.07 |

*Test analysis using a 1:10 plated dilution
**APC Test results come from inoculating three plates at a 1:10 ratio, a sensitivity of <3.33 cfu/g.

In view of the above, it will be seen that the several aspects of the invention are achieved and other advantageous results attained.

When introducing elements of the present invention or the preferred embodiment(s) thereof, the articles “a”, “an”, and “the” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

### REFERENCES

All references cited in the preceding text of the patent application or in the following reference list, to the extent that they provide exemplary, procedural, or other details supplementary to those set forth herein, are specifically incorporated by reference to the same extent as if each individual publication or patent application was specifically and individually indicated to be incorporated by reference.
1. Hauschild, A. H. W. and K. L. Dodds. 1993. Clostridium botulinum: Ecology and Control in Foods, Marcel Dekker, Inc., New York.
2. ICMSF (International Commission on Microbiological Specifications for Foods). 1996. Microorganisms in Foods 5: Characteristics of Microbial Pathogens, Blackie Academic Et Professional, London.
3. Meer, R. R., J. Baker, F. W. Bodyfelt, and M. W. Griffiths. 1991. Psychrotrophic Bacillus spp. in fluid milk products: a review. J. Food Prot. 54(12): 969-979.
4. Shehata, T. E. and E. B. Collins. 1972. Sporulation and heat resistance of strains of Bacillus. J. Dairy Sci. 55:1405-1409.
5. AOAC 17th Ed. 2000. Vol I, Microbiological Methods, Chpt. 17.
6. Compendium of Methods for the Microbiological Examination of Foods, 4th Ed. 2002, American Public Health Association (APHA).

What is claimed is:

1. An extended refrigerated shelf life mashed potato product having an aerobic plate count of less than 3.3 cfu/g and a mold and yeast count of less than 10 cfu/g whereby the product does not include chemical preservatives.

2. The mashed potato product of claim 1, further having a total coliform count of less than 10 cfu/g.

3. The mashed potato product of claim 1, having a refrigerated shelf life of from about 70 to about 130 days.

4. The mashed potato product of claim 1, wherein the mashed potato product has an appearance, flavor, and texture score on a nine-point hedonic scale of equal to or greater than 6.8.

5. A process for making an extended refrigerated shelf life mashed potato product, the process comprising:
a. preparing an amount of mashed potatoes;
b. heating the mashed potatoes at a temperature of at least about 212° F.;
c. maintaining the mashed potatoes at the heating temperature for at least 60 seconds;
d. cooling the mashed potatoes to a temperature of about 170° F. for from about 30 seconds to about 10 minutes; and,
e. filling the mashed potatoes into a gas and fluid impermeable, seated package.

6. The process of claim 5, wherein the process further consists of refrigerating the packaged mashed potatoes to a temperature of from about 33° F. to about 40° F.

7. The process of claim 5, wherein the heating temperature is from about 170° F. to about 230° F.

8. The process of claim 5, wherein the cooling temperature is from about 160° F. to about 180° F.

9. The process of claim 5, wherein preparing the mashed potatoes further comprises:
a. washing, peeling, and scrubbing fresh potatoes;
b. dicing and cooking the scrubbed potatoes; and,
c. mashing the cooked potatoes.

10. The process of claim 5, wherein the mashed potato product has from about a 2 to about a 6 log reduction of non-proteolytic C. botulinum spores as compared to the prepared mashed potatoes.

11. The process of claim 5, wherein the mashed potato product has from about a 1 to about a 3 tog reduction in B. cereus spores as compared to the prepared mashed potatoes.

12. The process of claim 5, wherein the mashed potato product has an appearance, flavor, and texture score on a nine-point hedonic scale of equal to or greater than 6.8.

13. A system for use in a process for making extended refrigerated shelf life mashed potatoes, the system comprising:
a. a heating apparatus to heat the mashed potatoes;
b. a circulating line for circulating the mashed potatoes from the exit of the heating apparatus through the circulating line to a cooling apparatus, the circulating line providing additional residence time to maintain the mashed potatoes at approximately the heating temperature;
c. a cooling apparatus to cool the mashed potatoes;
d. a transfer line for transporting the cooled mashed potatoes to a filling apparatus;
e. a steam valving apparatus in the transfer line to prevent bacterial recontamination of the cooled mashed potatoes; and,
f. a filling apparatus to fill the mashed potatoes into a gas and fluid impermeable, sealed package.

14. The system of claim 13, further comprising a refrigerating apparatus to cool the packaged mashed potatoes.

15. The system of claim 13, wherein the heating apparatus heats the mashed potatoes at a temperature of from about 170° F. to about 230° F.

16. The system of claim 13, wherein the cooling apparatus cools the mashed potatoes at a temperature of from about 160° F. to about 180° F.

17. The system of claim 13, wherein the heating apparatus is a heat exchanger.

18. The system of claim 17, wherein the heat exchanger is a scraped surface heat exchanger.

19. The system of claim 13, wherein the heating apparatus comprises multiple heat exchangers in series.

20. The system of claim 13, wherein the cooling apparatus is a heat exchanger.

21. The system of claim 20, wherein the heat exchanger is a scraped surface heat exchanger.

22. The system of claim 13, wherein the cooling apparatus comprises multiple heat exchangers in series.
